(19) United States
(12) Patent Application Publication
(10) Pub. No.: US 2004/0014625 A1
(43) Pub. Date: Jan. 22, 2004

(54) Ligand and complex for catalytically bleaching a substrate

(75) Inventors: Peter Comba, Heidelberg (DE); Jean Hypolites Koek, Vlaardingen (NL); Joachim Lienke, Vlaardingen (NL); Michael Merz, Heidelberg (DE); Lydmyla Tsymbal, Heidelberg (DE)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/454,202

(22) Filed: Jun. 4, 2003

(30) Foreign Application Priority Data
Jun. 6, 2002 (GB) 0212991.4
Jun. 12, 2002 (GB) 0213492.2

(51) Int. Cl. C11D 3/00

(52) U.S. Cl. 510/311; 510/312; 510/313

(57) ABSTRACT

The present invention provides a ligand, L, and transition metal complex thereof having the formula (I):

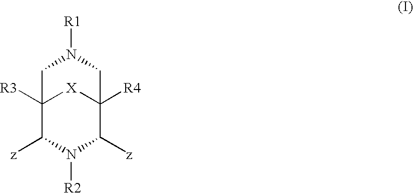

wherein at least one of R1 and R2 is a tertiary amine of the form —C2-C4-alkyl-NR7R8.

### FIELD OF INVENTION

This invention relates to a class of ligand and complexes thereof useful as catalysts for catalytically bleaching substrates.

### BACKGROUND OF INVENTION

The use of bleaching catalysts for stain removal has been developed over recent years. The recent discovery that some catalysts are capable of bleaching effectively in the absence of an added peroxyl source has recently become the focus of some interest, for example: WO9965905; WO0012667; WO0012808; and, WO0029537.

The search for new classes of compounds that are suitable as “air bleaching” and/or peroxyl bleaching catalysts is ongoing.

Various [3.3.1] bicyclo compounds and complexes thereof are discussed in the literature, see for example: Comba P. et al., J. Chem. Soc. Dalton Trans, 1998, (23) 3997-4001; Borzel et al. Chem. Eur. J. 1999, 5, No. 6, 1716 to 1721 and review by P. Comba in Coordination Chemistry Reviews 2000, 200-202, 217 to 245, entitled “Coordination compounds in the Entactic State”. These compounds are discussed in terms of their physical properties.

WO0060045 discloses a bleaching system comprising: a) from about 1 ppb, by weight of a transition metal catalyst comprising: i) a transition metal; ii) a ligand having formula (I):

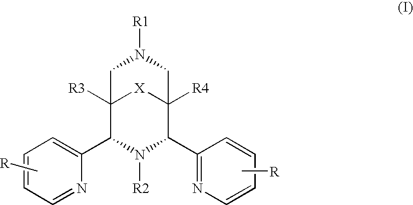

wherein each R is independently hydrogen, hydroxyl, C1-C4 alkyl, and mixtures thereof; R1 is C1-C4 alkyl, C6-C10 aryl, and mixtures thereof; R2 is C1-C4 alkyl, C6-C10 aryl, and mixtures thereof; R3 and R4 are each independently hydrogen, C1-C8 alkyl, C1-C8 hydroxyalkyl, benzyl ester, —(CH₂)ₙCO₂R5 wherein R5 is C1-C4 alkyl, x is from 0 to 4, and mixtures thereof; X is carbonyl, —C(R6)2- wherein each R6 is independently hydrogen, hydroxyl, C1-C4 alkyl, and mixtures thereof; b) optionally a source of hydrogen peroxide; and c) the balance carriers and adjunct ingredients. However, the teaching of WO0060045 limits substituents at the nitrogens (3 and 7 positions) of bicyclostructure to homoaromatic carbon groups, namely alkyl and aryl. The general bicyclo structure of Formula (I) is referred to as a bispidon.

### SUMMARY OF INVENTION

The compounds of the present invention may be used in bleaching compositions. The bleaching compositions may be those for use in “air mode” or “peroxyl mode”. The “air mode” compositions are substantially devoid of peroxyl species. The “peroxyl mode” compositions comprise a peroxyl species. The bleaching of a stain by a peroxyl species (peroxyl mode) is aided by the presence of an active transition metal catalyst. A peroxyl species commonly found in laundry bleaching compositions is hydrogen peroxide (H₂O₂) or a precursor thereof, e.g., sodium percarbonate or sodium perborate. In many instances an activator/precursor, e.g., TAED (tetraacetylethylene diamine), is present which serves together with hydrogen peroxide to form a peracid [RC(O)OOH] to facilitate bleaching.

Recently we have found that oily stains are bleached in the presence of selected transition metal catalysts in the absence of an added peroxyl source (air mode). The bleaching of an oily stain in the absence of an added peroxyl source has been attributed to oxygen derived from the air. Whilst it is true that bleaching is effected by oxygen sourced from the air the route in which oxygen plays a part is becoming understood. In this regard, the term “air bleaching” is used.

We have concluded from our research that bleaching of a chromophore in an oily stain is effected by products formed by adventitious oxidation of components in the oily stain. These products, alkyl hydroperoxides, are generated naturally by autoxidation of the oily stain and the alkyl hydroperoxides together with a transition metal catalyst serve to bleach chromophores in the oily stain. Alkyl hydroperoxides (ROOH) are generally less reactive that other peroxy species, for example, peracids (RC(O)OOH), hydrogen peroxide (H2O2), percarbonates and perborates.

It is an object of the present invention to provide alternative ligands and transition metal complexes thereof to those currently available.

Our earlier filed application PCT/EP01/13314, filed Nov. 15, 2002, which claims priority from GB0030673.8, filed Dec. 15, 2000, discloses the use of various bispidon compounds. Referring to the structure above, PCT/EP01/13314 teaches that there is an advantage to be secured by having at least one of R1 and R2 as group containing a heteroatom capable of coordinating to a transition metal. We have now found that by having at least one of R1 and R2 as a group that is a tertiary amine linked to one or more of the nitrogen atoms of the bicyclo structure by a C2 to C4 alkyl chain further advantages are secured. In addition, we have also found that heterocycles other than pyridyl may be used at the 2 and 4 positions.

Accordingly, in a first aspect, the present invention provides a transition metal complex of a ligand, L, having the formula (I):

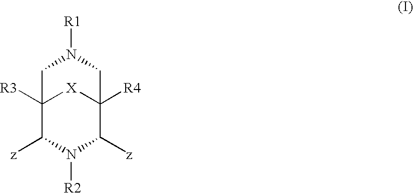

wherein at least one of R1 and R2 is a tertiary amine of the form —C2-C4-alkyl-NR7R8, the —C2-C4-alkyl- of the —C2-C4-alkyl-NR7R8 may be substituted by 1 to 4 C1-C2-alkyl, or may form part of a C3 to C6 saturated alkyl ring, R7 and R8 are independently selected from the group consisting of straight chain-C1-C12-alkyl, branched-C1-C12-alkyl or cyclo-C1-C12-alkyl, —CH2C6H5, and in which R7 and R8 may together form a cyclic ring selected from the group:

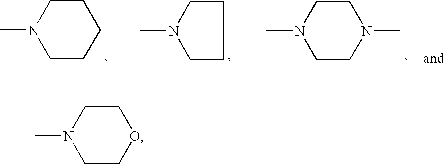

the other of R1 and R2 being independently selected from:

—C2-C4-alkyl-NR7R8 as defined above,

—C1-C24-alkyl;

—C1-C4-alkyl-C6-C10-aryl;

—C0—C1-alkyl-phenol, —C2-C3-alkyl-thiol, —C2-C3-alkyl-alcohol, and a —C1-C3-alkyl-carboxylate;

a heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; tetrahydropyranyl; and oxazolidinyl, wherein the heterocycloalkyl may be connected to the ligand via any atom in the ring of the selected heterocycloalkyl,

a —C1-C6-alkyl-heterocycloalkyl, wherein the heterocycloalkyl of the —C1-C6-heterocycloalkyl is selected from the group consisting of: piperidinyl; piperidine; 1,4-piperazine, tetrahydrothiophene; tetrahydrofuran; pyrrolidine; and tetrahydropyran, wherein the heterocycloalkyl may be connected to the —C1-C6-alkyl via any atom in the ring of the selected heterocycloalkyl, a —C1-C6-alkyl-heteroaryl, wherein the heteroaryl of the —C1-C6-alkylheteroaryl is selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the —C1-C6-alkyl via any atom in the ring of the selected heteroaryl and the selected heteroaryl is optionally substituted by —C1-C4-alkyl;

R3 and R4 are independently selected from the group consisting of: —C(O)O—C1-C24-alkyl, —C(O)O—C6H6, —C(O)O-benzyl, —CH2OC(O)C1-C20-alkyl, phenyl, CN, hydrogen, methyl, and C1-alkyl-OR wherein R is selected from the group consisting of H, C1-C24-alkyl, and benzyl;

X is selected from: C═O, a ketal or thioketal derivative of C═O selected from a group of the form:

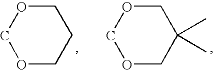

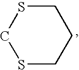

and

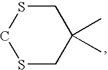

and —C(R6)₂ wherein each R6 is independently selected from hydrogen, hydroxyl, O—C1-C24-alkyl, O-benzyl, O—(C═O)—C1-C24, C1-C24-alkyl; and

z groups are same heteroaromatic groups of the form:

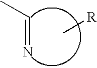

selected from the group consisting of: pyridinyl; imidazolyl; benzimidazolyl; and thiazolyl, wherein R is independently selected from: hydrogen, F, Cl, Br, hydroxyl, O—C1-C4-alkyl, C1-C4-alkyl-, —NH—CO—H, —NH—CO—C1-C4-alkyl, —NH2, and —NH—C1-C4-alkyl,

the transition metal complex of the general formula (A1):

[MₐLₖXₙ]Yₘ (A1)

in which:

M represents a metal selected from Mn(II)-(III)-(IV)-(V), Cu(I)-(II)-(III), Fe(II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI);

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents an integer from 0 to 10;

m represents zero or an integer from 1 to 20; and

L represents the ligand as defined above or its protonated or deprotonated analogue.

Accordingly, in a second aspect, the present invention provides the free ligand, L, of the transition metal complex as defined herein with the proviso that the following two ligands are excluded:

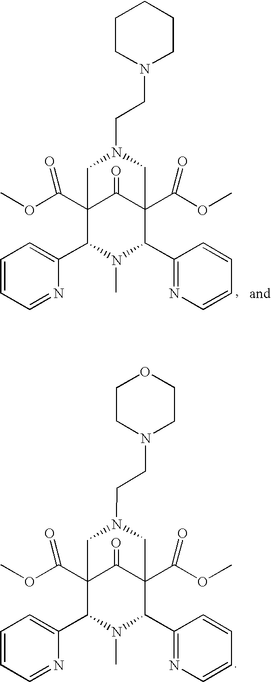

The transition metal complex and/or ligand, L, may be incorporated in a bleaching composition substantially devoid of a peroxygen bleach or a peroxy-based or peroxyl-generating bleach system, or conversely one with a peroxyl species or source thereof.

The term “substantially devoid of a peroxygen bleach or a peroxy-based or peroxyl-generating bleach system” should be construed within spirit of the invention. It is preferred that the composition has as low a content of peroxyl species present as possible. It is preferred that the bleaching formulation contains less that 1% wt/wt total concentration of peracid or hydrogen peroxide or source thereof, preferably the bleaching formulation contains less that 0.3% wt/wt total concentration of peracid or hydrogen peroxide or source thereof, most preferably the bleaching composition is devoid of peracid or hydrogen peroxide or source thereof. In addition, it is preferred that the presence of alkyl hydroperoxides is kept to a minimum in a bleaching composition comprising the ligand or complex of the present invention.

An advantage of the class of ligand and complex according to the present invention is that the complex can catalyse bleaching of a substrate via atmospheric oxygen, thus permitting its use in a medium such as an aqueous medium that is substantially devoid of peroxygen bleach or a peroxy-based or -generating bleach system. We have also found that complexes of this class are surprisingly effective in catalysing bleaching of the substrate via atmospheric oxygen after treatment of the substrate.

One skilled in the art will appreciate that not all peroxyl activating catalysts are capable of providing discernable bleaching activity with adventitious hydroperoxides present in a stain. However, in general the converse is not true. In this regard, all “air bleaching” catalysts disclosed herein may be used as a peroxyl activating catalyst. Catalysts of the present invention may be incorporated into a composition together with a peroxyl species or source thereof. For a discussion of acceptable ranges of a peroxyl species or source thereof and other adjuvants that may be present the reader is directed to U.S. Pat. No. 6,022,490, the contents of which are incorporated by reference.

Particularly preferred peroxyl species are sodium perborate tetrahydrate and, especially, sodium perborate monohydrate. Sodium perborate monohydrate is preferred because of its high active oxygen content. Sodium percarbonate may also be preferred for environmental reasons. The amount thereof in the composition of the invention usually will be within the range of about 1-35% by weight, preferably from 5-25% by weight. One skilled in the art will appreciate that these amounts may be reduced in the presence of a bleach precursor e.g., N,N,N′N′-tetraacetyl ethylene diamine (TAED).

### DETAILED DESCRIPTION OF THE INVENTION

The ligand as described herein is capable of dynamic inversion. The ability of the ligand to chelate to a TM depends upon the stereochemistry of the substituents. It is preferred that substituents are endo-endo, but it is likely that stereochemical conversion takes place by retro-Mannich conversion. Retro-Mannich may be prevented by changing the groups present such that retro-Mannich reactions are unfavoured. Nevertheless, it is likely that endo-exo and exo-exo ligands as described herein coordinate to transition metal ions in many instances and are capable of functioning as air bleaching catalysts.

The following are preferred features with regard to the transition metal complex and ligand thereof.

It is preferred that z are same. It is preferred that z is

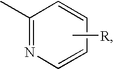

wherein R is independently selected from: hydrogen, F., Cl, Br, hydroxyl, O—C1-C4-alkyl, C1-C4-alkyl-, —NH—CO—H, —NH—C0-C1-C4-alkyl, —NH2, and —NH—C1-C4-alkyl, it is most preferred that R is H.

Preferred —C2-C4-alkyl-NR7R8 groups are those of the following: —CH2CH2-NR7R8, —CH2CMe2-NR7R8, —CMe2CH2-NR7R8, —CMeHCH2-NR7R8, —CMeHCMeH-NR7R8, —CH2CMeH-NR7R8, —CH2CH2CH2-NR7R8, —CH2CH2CMe2-NR7R8, —CH2CMe2CH2-NR7R8,

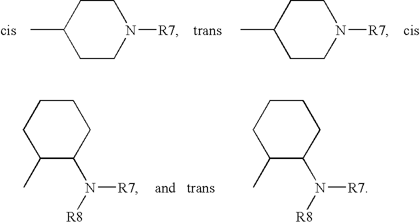

Examples of preferred R7 and R8 substituents are —CH3, —C2H5, —C3H7, —CH(CH3)2, —C4H9, —C5H11, —C6H13, —CH2C6H5

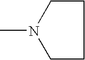

and

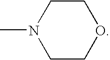

It is preferred that one or more of R7 and R8 is an alkyl chain of at least five carbon atoms that serves to increase the hydrophobisity of the ligand.

Of R1 and R2 is preferred that R1 is a C2-C4-alkyl-NR7R8, most preferably both R1 and R2.

Preferred heterocyclic groups formed by —NR7R8

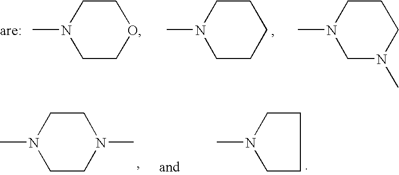

It is most preferred that R3=R4. R3 and R4 are preferably selected from the group consisting of —CH2OH, and —C(O)O-C1-C6-alkyl and —C(O)O-benzyl. Most preferred are those in which R3 and R4 are selected from the group consisting of: —C(O)—O—CH3, and —C(O)—O—CH2CH3.

It is preferred that X is selected from: C═O, CH2, C(OH)₂, syn-CH(OH), and anti-CH(OH), syn-CHOR and anti-CHOR, wherein R is H, C1-C24-alkyl or C(O)—C1-C24-alkyl. It is most preferred that X is C═O.

Preferred are ligands of the form:

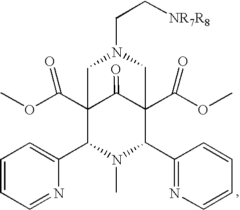

wherein —NR6R7 is selected from the group consisting of —NMe2, NEt2, —N(i-Pr)2, and

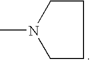

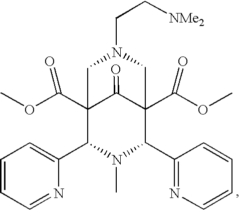

Examples of preferred ligands are:

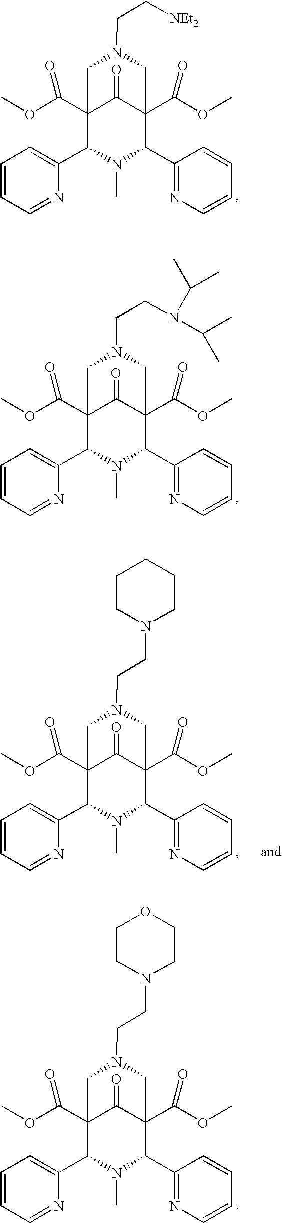

The catalyst may be used as a preformed complex of the ligand and a transition metal. Alternatively, the catalyst may be formed from the free ligand that complexes with a transition metal already present in the water or that complexes with a transition metal present in the substrate. The composition may also be formulated as a composition of the free ligand or a transition metal-substitutable metal-ligand complex, and a source of transition metal, whereby the complex is formed in situ in the medium.

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

The ligand forms a complex of the general formula (A1):

[MₐLₖXₙ]Yₘ (A1)

in which:

M represents a metal selected from Mn(II)-(III)-(IV)-(V), Cu(I)I(II)-(III), Fe(II)-(III)-(IV)-(V), Co(I)I(II)-(III), Ti(II)-(III)-(IV), V(II)-(III)-(IV)-(V), Mo(II)-(III)-(IV)-(V)-(VI) and W(IV)-(V)-(VI), preferably selected from Fe(II)-(III)-(IV)-(V);

L represents a ligand as herein defined, or its protonated or deprotonated analogue;

X represents a coordinating species selected from any mono, bi or tri charged anions and any neutral molecules able to coordinate the metal in a mono, bi or tridentate manner, preferably selected from O²⁻, RBO₂²⁻, RCOO⁻, RCONR⁻, OH⁻, NO₃⁻, NO, S₂⁻, RS⁻, PO₄³⁻, P₃OR³⁻, H₂O, CO₃²⁻, HCO₃⁻, ROH, N(R)₃, ROO⁻, O₂²⁻, O₂⁻, RCN, Cl⁻, Br⁻, OCN⁻, SCN⁻, CN⁻, N⁻, F⁻, I⁻, RO⁻, ClO₄⁻, and CF₃SO₃⁻, and more preferably selected from O²⁻, RBO₂²⁻, RCOO⁻, OH—, NO₃⁻, S²⁻, RS⁻, PO₃⁴⁻, H₂O, CO₃²⁻, HCO₃⁻, ROH, N(R)₃, Cl⁻, Br⁻, OCN⁻, SCN⁻, RCN, N₃⁻, F⁻, I⁻, RO⁻, ClO₄⁻, and CF₃SO₃⁻;

Y represents any non-coordinated counter ion, preferably selected from ClO₄⁻, BR₄⁻, [MX₄]⁻, [MX₄]²⁻, PF₆⁻, RCOO⁻, NO₃⁻, RO⁻, N⁺(R)₄, RO⁻, O₂²⁻, O₂⁻, Cl⁻, Br⁻, F⁻, I⁻, CF₃SO₃⁻, S₂O₆²⁻, OCN⁻, SCN, H₂O, RBO₂²⁻, BF₄⁻ and BPh₄⁻, and more preferably selected from ClO₄⁻, BR₄⁻, [FeCl₄]⁻, PF₆⁻, RCOO⁻, NO₃⁻, RO⁻, N⁺(R)₄, Cl⁻, Br⁻, F⁻, I⁻, CF₃SO₃⁻, S₂O₆²⁻, OCN⁻, SCN⁻, H₂O and BF₄⁻;

a represents an integer from 1 to 10, preferably from 1 to 4;

k represents an integer from 1 to 10;

n represents an integer from 1 to 10, preferably from 1 to 4;

m represents zero or an integer from 1 to 20, preferably from 1 to 8; and

each R independently represents a group selected from hydrogen, hydroxyl, —R′ and —OR′, wherein R′=alkyl, alkenyl, cycloalkyl, heterocycloalkyl, aryl, heteroaryl or a carbonyl derivative group, R′ being optionally substituted by one or more functional groups E, wherein E independently represents a functional group selected from —F, —Cl, —Br, —I, —OH, —OR′, —NH₂, —NHR′, —N(R′)₂, —N(R′)₃⁺, —C(O)R′, —OC(O)R′, —COOH, —COO⁻ (Na⁺, K⁺), —COOR′, —C(O)NH₂, —C(O)NHR′, —C(O)N(R′)₂, heteroaryl, —R′, —SR′, —SH, —P(R′)₂, —P(O)(R′)₂, —P(O)(OH)₂, —P(O) (OR′)₂, —NO₂, —SO₃H, —SO₃⁻(Na⁺, K⁺), —S(O)₂R′, —NHC(O)R′, and —N(R′)C(O)R′, wherein R′ represents cycloalkyl, aryl, arylalkyl, or alkyl optionally substituted by —F, —Cl, —Br, —I, —NH₃⁺, —SO₃H, —SO₃⁻(Na⁺, K⁺), —COOH, —COO⁻(Na⁺, K⁺), —P(O)(OH)₂, or —P(O) (O⁻(Na⁺, K⁺))₂, and preferably each R independently represents hydrogen, optionally substituted alkyl or optionally substituted aryl, more preferably hydrogen or optionally substituted phenyl, naphthyl or C1-4-alkyl.

The counter ions Y in formula (Al) balance the charge z on the complex formed by the ligand L, metal M and coordinating species X. Thus, if the charge z is positive, Y may be an anion such as RCOO⁻, BPh₄⁻, ClO₄⁻, BF₄⁻, PF₆⁻, RSO₃⁻, RSO₄⁻, SO₄²⁻, NO₃⁻, F⁻, Cl⁻, Br⁻, or I⁻, with R being hydrogen, optionally substituted alkyl or optionally substituted aryl. If z is negative, Y may be a common cation such as an alkali metal, alkaline earth metal or (alkyl)ammonium cation.

Suitable counter ions Y include those which give rise to the formation of storage-stable solids. Preferred counter ions for the preferred metal complexes are selected from R⁷COO⁻, ClO₄⁻, BF₄⁻, PF₆⁻, RSO₃⁻ (in particular CF₃SO₃⁻), RSO₄⁻, SO₄²⁻, NO₃⁻, F⁻, Cl⁻, Br⁻, and I⁻, wherein R represents hydrogen or optionally substituted phenyl, naphthyl or C₁-C₄ alkyl.

It will be appreciated that the complex (Al) can be formed by any appropriate means, including in situ formation whereby precursors of the complex are transformed into the active complex of general formula (A1) under conditions of storage or use. Preferably, the complex is formed as a well-defined complex or in a solvent mixture comprising a salt of the metal M and the ligand L or ligand L-generating species. Alternatively, the catalyst may be formed in situ from suitable precursors for the complex, for example in a solution or dispersion containing the precursor materials. In one such example, the active catalyst may be formed in situ in a mixture comprising a salt of the metal M and the ligand L, or a ligand L-generating species, in a suitable solvent. Thus, for example, if M is iron, an iron salt such as FeSO₄ can be mixed in solution with the ligand L, or a ligand L-generating species, to form the active complex. Thus, for example, the composition may formed from a mixture of the ligand L and a metal salt MXₙ in which preferably n=1-5, more preferably 1-3. In another such example, the ligand L, or a ligand L-generating species, can be mixed with metal M ions present in the substrate or wash liquor to form the active catalyst in situ. Suitable ligand L-generating species include metal-free compounds or metal coordination complexes that comprise the ligand L and can be substituted by metal M ions to form the active complex according the formula (A1).

The catalysts according to the present invention may be used for laundry cleaning, hard surface cleaning (including cleaning of lavatories, kitchen work surfaces, floors, mechanical ware washing etc.). As is generally known in the art, bleaching compositions are also employed in waste-water treatment, pulp bleaching during the manufacture of paper, leather manufacture, dye transfer inhibition, food processing, starch bleaching, sterilisation, whitening in oral hygiene preparations and/or contact lens disinfection.

In typical washing compositions the level of the organic substance is such that the in-use level is from 1 μM to 50 mM, with preferred in-use levels for domestic laundry operations falling in the range 10 to 100 μM. Higher levels may be desired and applied in industrial bleaching processes, such as textile and paper pulp bleaching. These levels reflect the amount of catalyst that may be present in a wash dose of a detergent composition. The bleaching composition comprises at least 1 ppb of the ligand or complex thereof.

In the context of the present invention, bleaching should be understood as relating generally to the decolourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light.

Synthesis

In addition to the utility of the ligands and complexes of the present invention as catalysts another advantage is that the ligands are generally relatively easy to synthesize in comparison to other ligands. The following is one example of a strategic synthetic approach; it will be evident to one skilled in the art of synthetic organic chemistry that many approaches may be taken to obtain ligands and complexes for use in the present invention. The ease of synthesis of the ligand of Formula (I) is dependent upon the nature of substituents about the structure. The ligands of Formula (I) are most preferably symmetric. Synthesis of these types of molecules are found in articles by U. Holzgrabe et al. in Arch. Pharm. (Weinheim, Ger.) 1992, 325, 657 and A. Samhammer et al. Arch. Pharm. (Weinheim, Ger.) 1984, 322, 557. Below is given a schematic example illustrating the ease of synthesis. The synthesis is shown in a two step synthesis, Scheme 1 and Scheme 2, but in some cases may be conducted as a “one-pot” synthesis depending upon the nature of the substituents. Nevertheless, where substituents at positions 7 and 3 are different a two step synthesis is preferred. The product of reaction as found in Scheme 1 is referred to as dimethyl 2,6-di-(2-pyridyl)-1-methyl-piperid-4-one-3,5-dicarboxylate (NPy2), which can easily tautomerize to the enol. The synthesis is exemplified in R. Haller, K. W. Merz, Pharm. Acta Helv., 1963, 442.

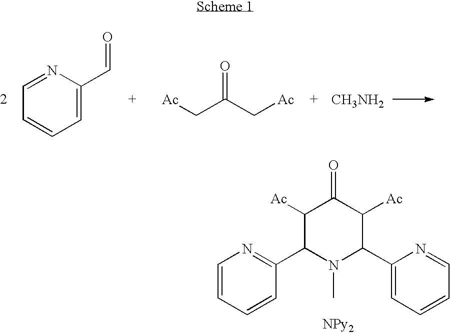

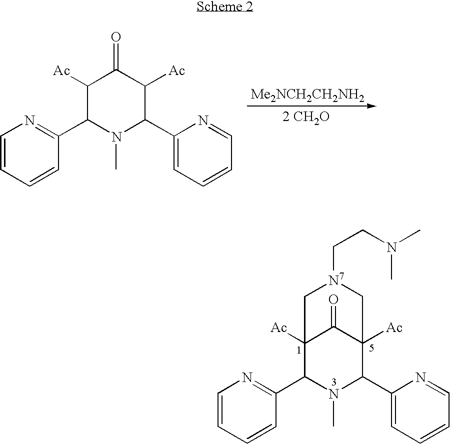

Another intermediate that may be produced according to the general teachings of Scheme 1 wherein MeNH₂ is replaced by Me₂NCH₂CH₂NH₂ such that a product referred to as dimethyl-2,6-di-(2-pyridyl)-1-(N,N-dimethylamino)ethylene-piperid-4-one-3,5-dicarboxylate is produced, the structure of which is given below.

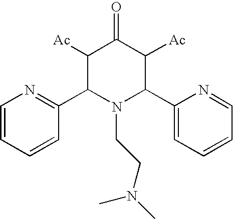

One skilled in the art will appreciate that whilst Ac [—CO(O)Me] is an electron withdrawing group and electron withdrawing groups are generally preferred to facilitate synthesis other groups will also allow the reaction to proceed. Examples of suitable electron withdrawing groups are given above and will be evident to one skilled in the art. The reaction is also driven by precipitation of the product from solution.

In instances, depending upon the nature of the substituents, for example a phenolic group, it will be necessary to protect certain functional groups. The choice of protecting groups during synthesis to prevent undesirable reactions will be evident to one skilled in the art. For a discussion of protecting groups in organic synthesis the reader is directed to T. W. Green and P. G. M. Wuts, Protective Groups In Organic Synthesis 3nd Ed.; J. Wiley and Sons, 1999. It will be evident that if a diamine is substituted for methylamine in the reaction illustrated in Scheme 2 two structures may be linked together via the 7 positions as found in the structure below.

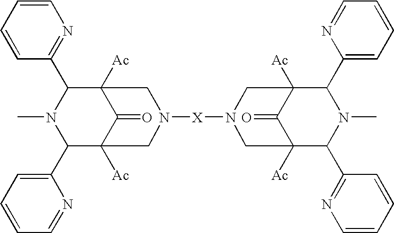

In addition, if a diamine is substituted for methylamine in the reaction illustrated in Scheme 1 a NPy2 structure is formed that is linked at the 3 positions. Obviously, this dimer would serve as a precursor to other dimer and polymer type structures. The present invention is confined to “monomer” ligands and not the dimer and polymer units linked by a covalent bond as described above. The term “monomer” as used herein is used to exclude these products in which covalently linked polyligand type structures are formed.

The Detergent Composition.

The ligand and/or transition metal complex thereof may be used in a detergent composition specifically suited for stain bleaching purposes. To that extent, the composition comprises a surfactant and optionally other conventional detergent ingredients. The ligand and/or transition metal complex thereof may be part of an enzymatic detergent composition that comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C11-C15 alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

The invention will now be further illustrated by way of the following non-limiting examples:

### EXAMPLES

The ligand N,N-bis(pyridin-2-yl-methyl)-1,1-bis(pyridin-2-yl)-1-aminoethane (MeN4py) was prepared as described in EP 0 909 809 A2. The synthesis of the iron complex, [(MeN4Py)FeCl]Cl, has been described elsewhere (WO 0116271.

Synthesis

Procedure for Bispidone Synthesis:

A suspension of 7.15 g (16.3 mmol) of piperidone (Npy2) (synthesis exemplified in R. Haller, K. W. Merz, Pharm. Acta Helv., 1963, 442) in 40 ml ethanol is treated with 1.72 g (19.6 mmol) of N,N-dimethylethylendiamine and 3.5 ml of formaldehyde (37% in water)—36.1 mmol) and is refluxed for 30 min. The resulting clear, slight yellow to dark brown reaction solution is evaporated to half of its volume and left at 5° C. for 24 h. The yellow precipitate formed is filtered, washed with little EtOH until the precipitate is white and dried under high vacuum.

If no precipitate is obtained, the reaction mixture is evaporated to dryness, dissolved in as little EtOH as possible and left at 5° C. for 72 h.

Analytical Data:

Melting point: 147° C.

CHN analysis:

calc. (%) C 63.02H 6.71 N 14.13

found (%) C 62.69H 6.76 N 13.79

FAB⁺MS (NBA): 496.3 (MH⁺); C₂₆H₃₃N₅O₅ M=495.25 g/mol

IR[cm⁻¹]: 3039 (w), 2942 (m), 2779 (m), 2760 (m), 2708 (w), 1723 (s), 1587 (m), 1465 (m), 1431(m), 1270 (s), 1162 (m), 971 (m), 751 (m).

¹H-NMR (300. 133 MHz, CDCl₃): δ=1.98 (s, 3H, N—CH₃), 2.32 (bs, 6H, N—(CH₃)₂), 2.49 (bs, 4H, N—CH₂—), 2.61 (d, 2H, ²J_{HH}=12.1 Hz, —CH₂—), 3.12 (d, 2H, ²J_{HH}=9.5 Hz, —CH₂—), 3.79 (s, 6H, OCH₃), 4.66 (s, 2H, CH-Py), 7.20 (dt, 2H, ³J_{HH}=4.8 Hz, ⁴J_{HH}=1.1 Hz, Py-H), 7.73 (dt, 2H, ³J_{HH}=7.7 Hz, ⁴J_{HH}=1.8 Hz, Py-H), 8.11 (bd, 2H, ³J_{HH}=7.7 Hz, Py-H), 8.47 (dd, 2H, ³J_{HH}=8.5 Hz, ⁴J_{HH}=1.1 Hz, Py-H).

¹³C-NMR (75. 47 MHz, CDCl₃): δ=43.1 (1C, N—CH₃), 45.5 (2C, N—(CH₃)₂), 52.4 (2C, OCH3), 56.5 (2C, N—CH₂), 58.9 (2C, NCH₂), 62.4 (2C, C_{q,Alkyl}), 73.8 (2C, NCH), 122.9, 123.9, 136.3, 149.2 (8C, Ar—C), 158.6 (2C, Ar—C_{q}), 168.6 (2C, ester), 207.2 (1C, C═O).

Preparation of Complex 1

2 mmol of metal salt (FeCl2) dissolved in 1 ml methanol is added to 2 mmol of ligand dissolved in 1 ml acetotrile.

After 24 h stirring at RT the solution is concentrated to 0.5 ml total volumne and treated with 5 mL of ethylacetate. The solution is sonicated in an ultrasonic bath. The resulting solid is filtered in dried in high vacuum.

FeCl(N2Py2EtNMe2)]Cl C₂₆H₃₅Cl₂FeN₅O₆.H₂O M=640.34 g/mol

Analytical data:

CHN Analysis calc. (%) C 48.77H 5.51 N 10.94 found (%) C 49.15H 5.79 N 10.61

FAB⁺MS(NBA): 604.2 [FeCl(N2Py2EtNMe2H₂O)]H⁺.

Magnetic moment: μ=5.3 B.M

Redox potential: E_{1/2}: 847 mV in acetonitrile

IR [cm⁻¹]: 3136 (m, OH), 3094 (m), 2976 (m), 1716 (s), 1600 (m), 1472 (m), 1426 (m), 1274 (s), 784 (m), 648 (w).

UV-Vis (MeOH): 402 nm (ε=1651 cm² mol⁻¹), 313 nm (ε=925 cm² mol⁻¹), 250 nm (ε=5123 cm² mol⁻¹), 219 nm (ε=4354 cm² mol⁻¹).

Bleaching Experiments (Air Mode)

In an aqueous solution containing 10 mM carbonate buffer (pH 10) with 0.6 g/l NaLAS (linear alkylbenzene sulphonate tomato-soya oil or curry-soya oil stained cloths were added and kept in contact with the solution whilst agitating for 30 minutes at 30° C. Comparative experiments were performed using 10 μM of the metal complex referred to in the table below.

After the wash, the cloths were rinsed with water and subsequently dried at 30° C. and the change in colour was measured immediately after drying with a Linotype-Hell scanner (ex Linotype) (t=o in the table). The tomato stains were left for 24 h in the dark and measured again (t=1 in the table). The change in colour (including bleaching) is expressed as the ΔE value versus white; a lower ΔE value means a cleaner cloth. The measured colour difference (ΔE) between the washed cloth and the unwashed cloth is defined as follows:

ΔE=[(ΔL)²+(Δa)²+(Δb)²]^{1/2}

wherein ΔL is a measure for the difference in darkness between the washed and unwashed test cloth; Δa and Δb are measures for the difference in redness and yellowness respectively between both cloths. With regard to this colour measurement technique, reference is made to Commission International de l'Eclairage (CIE); Recommendation on Uniform Colour Spaces, colour difference equations, psychometric colour terms, supplement no 2 to CIE Publication, no 15, Colormetry, Bureau Central de la CIE, Paris 1978. The results are shown below in the tables.

Tomato oil (TOL)/pH10 with 0.6 g/l NaLAS

| | (t = 0) | (t = 1) |
|---|---|---|
| Blank | 20 | 20 |
| FeMeN4pyCl2 | 10 | 5 |
| Complex 1 | 11 | 6 |

Curry oil (COL)/pH10 with 0.6 g/l NaLAS

| | (t = 0) |
|---|---|
| Blank | 54 |
| FeMeN4pyCl2 | 46 |
| Complex 1 | 41 |

The experiments presented in the tables above show that the bispidon ligand carrying a tert-amine moiety provides an advantage.

1. A transition metal complex of a ligand, L, having the formula (I): 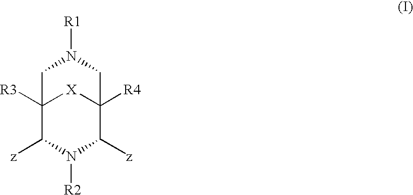
wherein at least one of R1 and R2 is a tertiary amine of the form —C2-C4-alkyl-NR7R8, the —C2-C4-alkyl- of the —C2-C4-alkyl-NR7R8 may be substituted by 1 to 4 C1-C2-alkyl, or may form part of a C3 to C6 saturated alkyl ring, R7 and R8 are independently selected from the group consisting of straight chain-C1-C12-alkyl, branched-C1-C12-alkyl or cyclo-C1-C12-alkyl, —CH2C6H5, and in which R7 and R8 may together form a cyclic ring selected from the group: 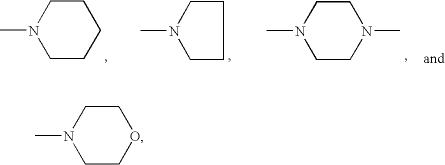
the other of R1 and R2 being independently selected from:
—C2-C4-alkyl-NR7R8 as defined above,
—C1-C24-alkyl;
—C1-C4-alkyl-C6-C10-aryl;
—C0-C1-alkyl-phenol, —C2-C3-alkyl-thiol, —C2-C3-alkyl-alcohol, and a —C1-C3-alkyl-carboxylate;
a heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; tetrahydropyranyl; and oxazolidinyl, wherein the heterocycloalkyl may be connected to the ligand via any atom in the ring of the selected heterocycloalkyl,
a —C1-C6-alkyl-heterocycloalkyl, wherein the heterocycloalkyl of the —C1-C6-heterocycloalkyl is selected from the group consisting of: piperidinyl; piperidine; 1,4-piperazine,tetrahydrothiophene; tetrahydrofuran; pyrrolidine; and tetrahydropyran, wherein the heterocycloalkyl may be connected to the —C1-C6-alkyl via any atom in the ring of the selected heterocycloalkyl, a —C1-C6-alkyl-heteroaryl, wherein the heteroaryl of the —C1-C6-alkylheteroaryl is selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the —C1-C6-alkyl via any atom in the ring of the selected heteroaryl and the selected heteroaryl is optionally substituted by —C1-C4-alkyl;
R3 and R4 are independently selected from the group consisting of: —C(O)O—C1-C24-alkyl, —C(O)O—C6H6, —C(O)O-benzyl, —CH2OC(O)C1-C20-alkyl, phenyl, CN, hydrogen, methyl, and C1-alkyl-OR wherein R is selected from the group consisting of H, C1-C24-alkyl, and benzyl;
X is selected from: C═O, a ketal or thioketal derivative of C═O selected from a group of the form: 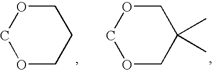 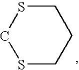
and 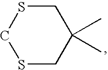
and —C(R6)₂ wherein each R6 is independently selected from hydrogen, hydroxyl, O—C1-C24-alkyl, O-benzyl, O—(C═O)—C1-C24, C1-C24-alkyl; and
z groups are same heteroaromatic groups of the form: 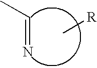
selected from the group consisting of: pyridinyl; imidazolyl; benzimidazolyl; and thiazolyl, wherein R is independently selected from: hydrogen, F, Cl, Br, hydroxyl, O—C1-C4-alkyl, C1-C4-alkyl-, —NH—CO—H, —NH—CO—C1-C4-alkyl, —NH2, and —NH—C1-C4-alkyl,
the transition metal complex of the general formula (A1):
[MₐLₖXₙ]Yₘ (A1)
in which:
M represents a metal selected from Mn(II)-(III)-(IV)-(V), Cu(I)I(II)-(III), Fe(II)-(III)-(IV)-(V), Co(I)I(II)-(III), Ti(II)-(III)-(IV), V(II)-(III)-(IV)-(V), Mo(II)-(III)-(IV)-(V)-(VI) and W(IV)-(V)-(VI);
X represents a coordinating species selected from any mono, bi or tri charged anions and any neutral molecules able to coordinate the metal in a mono, bi or tridentate manner;
Y represents any non-coordinated counter ion;
a represents an integer from 1 to 10;
k represents an integer from 1 to 10;
n represents an integer from 0 to 10;
m represents zero or an integer from 1 to 20; and
L represents the ligand as defined above or its protonated or deprotonated analogue.

2. A transition metal complex according to claim 1,
wherein z is 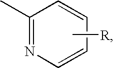
wherein R is independently selected from: hydrogen, F, Cl, Br, hydroxyl, O—C1-C4-alkyl, C1-C4-alkyl-, —NH—CO—H, —NH—C0-C1-C4-alkyl, —NH2, and —NH—C1-C4-alkyl.

3. A transition metal complex according to claim 1, wherein R is H.

4. A transition metal complex claim 1, wherein the —C2-C4-alkyl-NR7R8 is selected from the group consisting of: —CH2CH2-NR7R8, —CH2CMe2-NR7R8, —CMe2CH2-NR7R8, —CMeHCH2-NR7R8, —CMeHCMeH-NR7R8, —CH2CMeH-NR7R8, —CH2CH2CH2-NR7R8, —

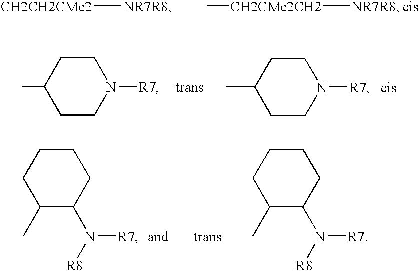

5. A transition metal complex claim 1, wherein the —C2-C4-alkyl-NR7R8R is a —C2-alkyl-NR7R8R.

6. A transition metal complex claim 1, wherein R7 and R8 are independently selected from the group consisting of —CH3, —C2H5, —C3H7, —C4H9, —C5H11, —C6H13, and —CH2C6H5.

7. A transition metal complex claim 1, wherein at least one of R7 and R8 is an alkyl chain of at least five carbon atoms.

8. A transition metal complex claim 1, wherein R7 and R8 are —CH3, —CH2CH3, —CH(CH3)2 or together form a cyclic structure selected from the group consisting of: 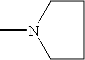
and

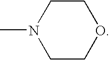

9. A transition metal complex claim 1, wherein R1 is a C2-C4-alkyl-NR7R8.

10. A transition metal complex claim 1, wherein one of R1 and R2 is —CH3

11. A transition metal complex claim 1, wherein R1 and R2 are both independently C2-C4-alkyl-NR7R8.

12. A transition metal complex claim 1, wherein —NR7R8 is selected from group consisting of:

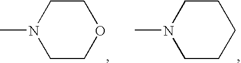

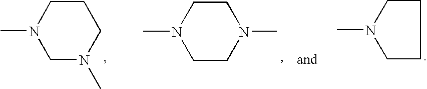

13. A transition metal complex claim 1, wherein: R3=R4.

14. A transition metal complex claim 1, wherein R3 and R4 are selected from the group consisting of —CH2OH, and —C(O)O—C1-C6-alkyl and —C(O)O-benzyl.

15. A transition metal complex claim 1, wherein R3 and R4 are selected from the group consisting of: —C(O)—O—CH3, and —C(O)—O—CH2CH3.

16. A transition metal complex claim 1, wherein X, is selected from C═O, CH2, C(OH)₂, syn-CH(OH), and anti-CH(OH), syn-CHOR and anti-CHOR, wherein R is H, C1-C24-alkyl or C(O)—C1-C24-alkyl.

17. A transition metal complex according to claim 1, wherein the ligand is: 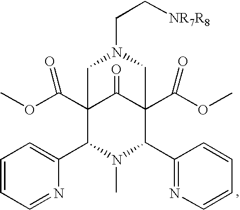
wherein —NR6R7 is selected from the group consisting of —NMe2, NEt2, —N(i-Pr)2, and

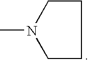

18. A transition metal complex according to claim 1, wherein the ligand, L, is selected from a the group consisting of:

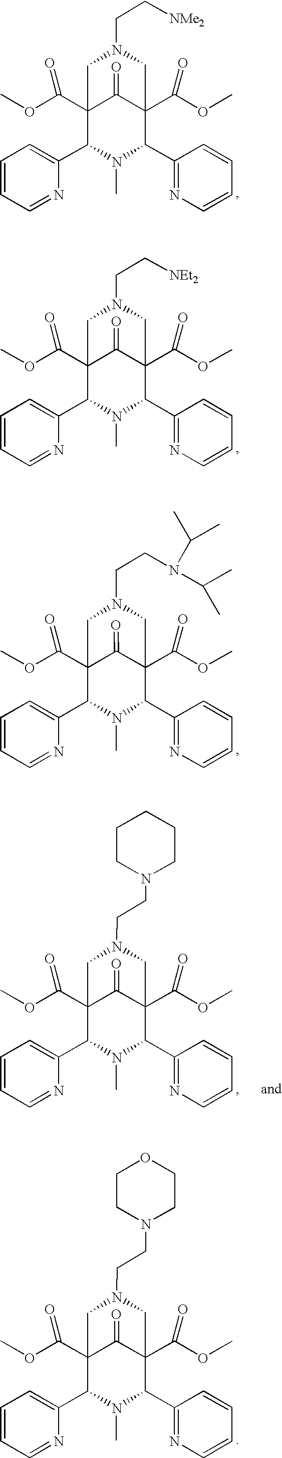

19. A transition metal complex claim 1, wherein M represents a metal selected from Fe(II)-(III)-(IV)-(V).

20. A transition metal complex according to claim 19, wherein M represents a metal selected from Fe(II) and Fe(III).

21. A transition metal complex according to claim 20, wherein the ligand is present in the form selected from the group consisting of [FeLCl]Cl and [FeL(H2O)](BF4)2.

22. A free ligand, L, of the transition metal complex as defined in any one of claim 1, with the proviso that the following two ligands are excluded: [chemical structure]
